(19) United States
(12) Patent Application Publication
(10) Pub. No.: US 2004/0046748 A1
(43) Pub. Date: Mar. 11, 2004

(54) Input panel device for an electronic device and method for using the same

(76) Inventor: Joong-kil Kwon, Suwon-city (KR)

Correspondence Address: Joseph J. Buczynski, Roylance, Abrams, Berdo & Goodman, L.L.P., Suite 600, 1300 19th Street, N.W., Washington, DC, 20036, US

(21) Appl. No.: 10/388,465

(22) Filed: Mar. 17, 2003

(30) Foreign Application Priority Data
Sep. 10, 2002 (KR) 2002-54539

(51) Int. Cl. G09G 5/00

(52) U.S. Cl. 345/173

(57) ABSTRACT

An input panel device adapted for use with an electronic device. The input panel device is coupled to the electronic device for inputting and selecting a desired operation from a user. The input panel device comprises a plurality of menu keys, a display which, upon selection of a menu key by the user, displays submenus pertaining to the selected menu, and a sensor array arrayed in a line inside the display which, upon selection of a submenu displayed on the display by the user, outputs signals having levels corresponding to the selected submenu. The input panel device further comprises a controller for calculating a central position of the sensors having changed output levels among the sensor array, and comparing the calculated central position with positions of the submenus displayed on the display to determine the selected submenu and inform the electric device of the selected submenu. The menus can thus be selected promptly and easily by using the light receiving and luminance elements.

This application claims benefit under 35 U.S.C. § 119 from Korean Patent Application No. 2002-54539, filed on Sep. 10, 2002, the entire content of which is incorporated herein by reference.

### BACKGROUND OF THE INVENTION

1. Field of the Invention

The present invention relates to an input panel device for an electronic device, and more particularly, to an input panel device for an electronic device capable of selecting a menu promptly and easily by using light receiving and luminous elements.

2. Description of the Related Art

Various apparatuses employ an electronic device that inputs a control signal from an input panel for various operations. FIG. 1 is a schematic view showing an inner structure of a conventional input panel device for an electronic device. As shown in FIG. 1, the conventional input panel device 100 includes a plurality of mode selection switches sw11 to swnn arrayed in a matrix of a plurality of columns and rows. Each of the mode selection switches sw11 to swnn is assigned to perform a specific function and operation.

A controller 102 is provided to check a physical contact of each of the mode selection switches to determine whether or not such contact is made. In one example, the mode selection switches are checked beginning with the first row to determine whether any switch in that row is closed. If none of them are closed, then each mode selection switch in the next row is checked. This may proceed to the last row until the controller 120 finds the selected mode selection switch that is closed.

Upon finding the selected mode selection switch, the controller 102 controls the electronic device (not shown) to perform a function assigned to the selected switch. As features of electronic devices become varied, the number of necessary keys for selection of the various operations increases, thus making it difficult to miniaturize the devices.

To resolve the above problem, input panel devices have been developed which include mode selection switches corresponding to menus, which have a plurality of submenus for each of them so that submenus can consequently be selected after the desired menu is selected by using a switch. However, the conventional input panel device may only perform the functions assigned to respective keys and not any non-assigned functions. This results in an increase in the number of keys for selection of the mode as the features of electronic devices become more complex.

The input panel device further has a problem in that users could not see what kind of submenus are associated with the upper menus. Therefore, a user will only be able to select the submenus via the upper menu if the user previously viewed and remembers those submenus. If the user selects the wrong upper menu, he or she has to return to another upper menu and start all over again.

### SUMMARY OF THE INVENTION

An object of the present invention is to solve at least the above problems and disadvantages and to provide at least the advantages described below.

Accordingly, an object of the present invention is to solve the foregoing problems by providing an input panel device for an electronic device to enable a user to select functions of the electronic device promptly and easily.

The foregoing object and advantages are substantially realized by providing an input panel device for an electronic device for inputting and selecting a desired operation. The input panel device comprises a plurality of menu keys, a display which, upon selection of a menu key by a user, displays submenus pertaining to the selected menu, and a sensor array arrayed in a line inside of the display which, upon selection of a submenu displayed on the display by the user, outputs signals having levels corresponding to the selected submenu. The input panel device further comprises a controller for calculating a central position of the sensors having changed output levels among the sensor array, and for comparing the calculated central position with positions of the submenus displayed on the display to determine the selected submenu to inform the electric device of the selected submenu. The input panel device of the electronic device further comprises a storage for storing positions and ranges of the submenus displayed on the display.

The sensor array of the input panel device of the electronic device can include luminous elements disposed inside of the display to emit light, and light receiving elements disposed in positions corresponding to the luminous elements to receive the light from the luminous elements, such that the light from the luminous elements in the vicinity of the selected submenu is obstructed from being received by their respective light receiving elements upon selection of the submenu, resulting in the respective light receiving elements outputting signals having levels different from the levels of signals output by the respective light receiving elements when they receive light from their respective luminous elements.

The number of light receiving and luminous elements may depend on their features and a resolution of the display. However, the number of the luminous elements is preferably matched with the number of the submenus, and is typically smaller than that of the light receiving elements.

Additional advantages, objects, and features of the embodiments of the invention will be set forth in part in the description which follows and in part will become apparent to those having ordinary skill in the art upon examination of the following, or may be learned from practice of the invention. The objects and advantages of the embodiments of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic view showing an inner structure of a conventional input panel device for an electronic device;

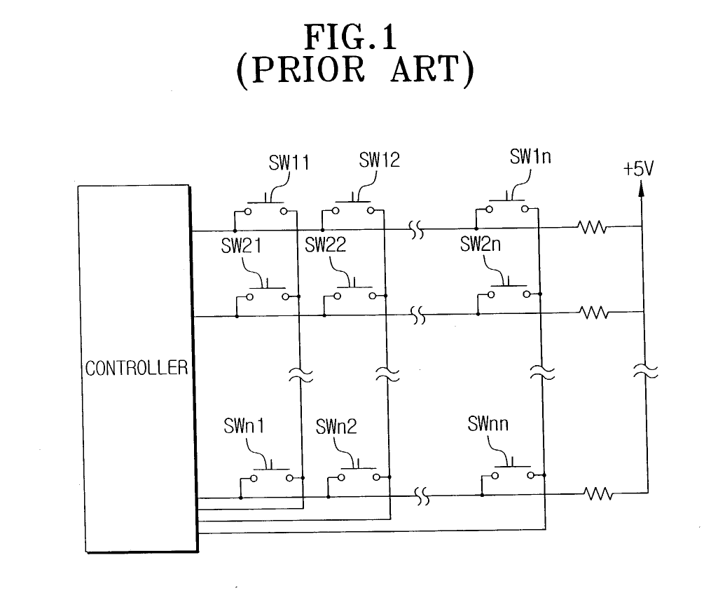

FIG. 2 is a block diagram showing an input panel device for an electronic device according to an embodiment of the present invention;

FIG. 3 is a vertical sectional view of the input panel device of FIG. 2; and

FIG. 4 is a flow chart illustrating an example of the operation of the input panel device according to an embodiment of the present invention.

### DETAILED DESCRIPTION OF THE PREFERRED EMBODIMENT

The following detailed description will present an input panel device for an electronic device according to an embodiment of the invention in reference to the accompanying drawings.

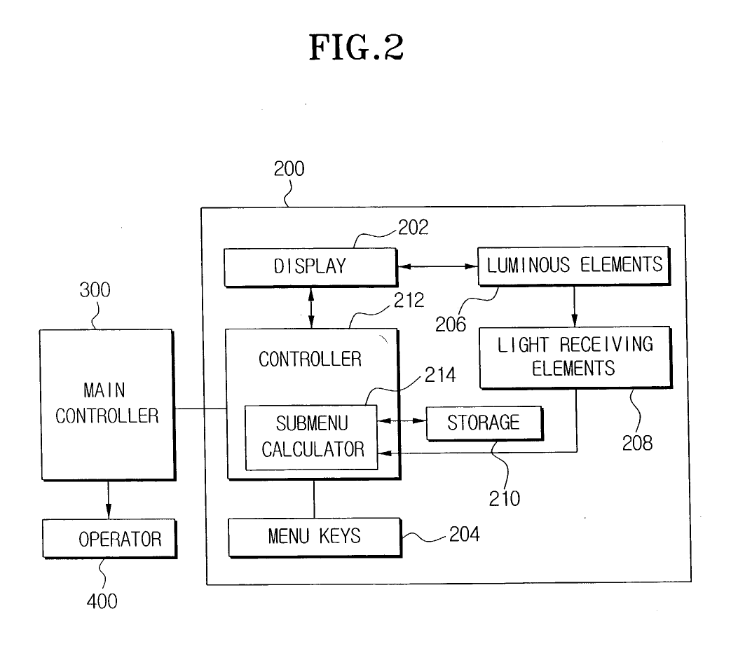

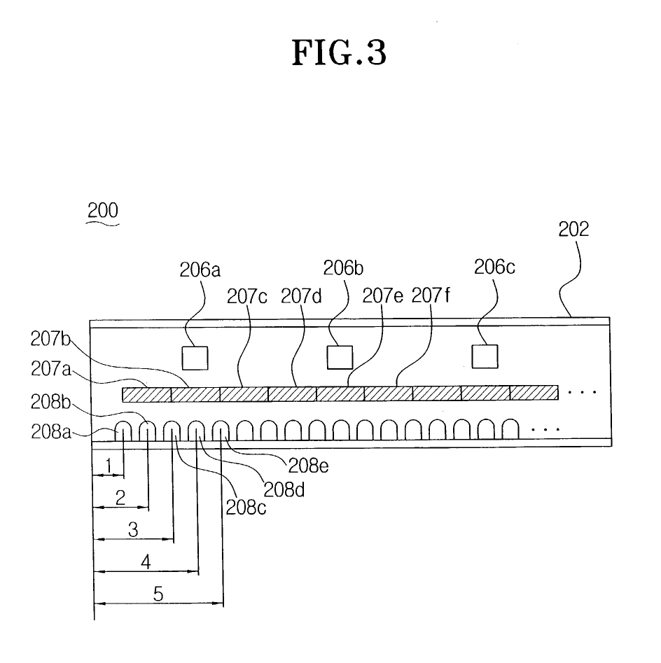

FIG. 2 is a block diagram showing an input panel device for an electronic device according to an embodiment of the present invention. FIG. 3 is a vertical sectional view of the input panel device of FIG. 2.

Generally, the input panel device 200 is mounted on a surface of the electronic device (not shown), and has a plurality of buttons 204, for example, menu keys, via which a user can select a desired function of the electronic device. An input menu is input via the input panel 200 to a main controller 300 of the electronic device. The main controller 300 controls an operator 400 to perform a function corresponding to a requested submenu.

Referring to FIGS. 2 and 3, the input panel device 200 in accordance with an embodiment of the present invention comprises a display 202, a plurality of menu keys 204, a luminous element 206, a light receiving element 208, a storage 210 and a controller 212. The display 202 displays image or text information in the form of image in response to the menu selection of the user.

If the electronic device is, for example, a printer, the available functions for the electronic device can include, for example, discharging a sheet of paper, test printing, initiating printing and the like. These functions are classified into several categories, each of which has a hierarchy structure, such that the functions can be represented by a plurality of submenus corresponding to an upper menu. Preferably, the menu keys 204 are matched with the functions of the electronic device corresponding to the upper menus.

When a function is selected by the user via the menu keys 204, the display 202 displays submenus 207 corresponding to the upper menu which is assigned to the selected menu key. This enables the user to see respective submenus 207 corresponding to the menu keys 204.

The display 202 has a series of a plurality of luminous elements 206 disposed inside the display. The luminous elements 206 can include luminous sensors which emit infrared, visible or ultraviolet light at a specific level and angle. The number of luminous elements 206 may depend on their features and a resolution of the display 202. However, it is preferable for the number of luminous elements to be matched with the number of the submenus 207.

The light receiving elements 208 are placed in series to correspond to the luminous elements 206, and thus can receive the light emitted from the luminous elements 206 (refer to FIG. 3). The light receiving elements 208 receive the infrared, visible or ultraviolet light to output a signal having a level corresponding to the amount of the received light. The number of light receiving elements 207 may depend on their features and the resolution of the display 202. However, it is preferable that the number of light receiving elements 207 be larger than the number of luminous elements 206.

The luminous elements 206 emit light normally. When the user selects one of the submenus 207 displayed on a screen of the display 202 by using, for example, his or her finger, the light from the luminous elements in the vicinity of the selected submenu 207 is partially obstructed. This causes one or more of the light receiving elements 208 to change their respective output levels because these light receiving elements 208 do not receive light having the same intensity as unobstructed light.

The storage 210 stores positions and ranges of the submenus displayed on the display. Conventionally, a register, DRAM (Dynamic Random Access Memory), SRAM (Static Random Access Memory), Flash ROM (Read Only Memory) or the like can be used as the storage 210.

The controller 212 controls overall operations of the electronic device. The controller 212 includes a submenu calculator 214. The submenu calculator 214 determines the light receiving elements 208 having the changed levels, which are the light receiving elements 208 shadowed by the finger of the user. The submenu calculator 214 then calculates a central position in the determined elements. The submenu calculator 214 consequently compares the calculated value with positions of the submenus stored at the storage 210 to locate the submenu corresponding to the calculated value.

A detailed description of the operations described above will now be given with reference to FIG. 3. As shown in FIG. 3, the position of the submenu 207b is stored as “4” from a point A with range from “3” to “5”, while the positions of the light receiving elements 208c, 208d and 208e are stored as “3”, “4” and “5”, respectively. Assuming the user selects the submenu 207b out of the submenus 207, this causes the light receiving elements 208c, 208d and 208e among the light receiving elements 208 to change their output levels. The submenu calculator 214 then calculates a central position “4” by averaging the positions “3”, “4” and “5” of the light receiving elements 208c, 208d and 208d. As a result, the submenu calculator 214 may detect that the submenu 207b, which is within the range including “4”, has been selected by the user. The controller 212 informs the main controller 300 of the selected submenu 207b, and the controller 300 controls the operator 400 to perform the function corresponding to the submenu 207b.

A further description of the operation of the input panel device according to an embodiment of the invention is set forth below.

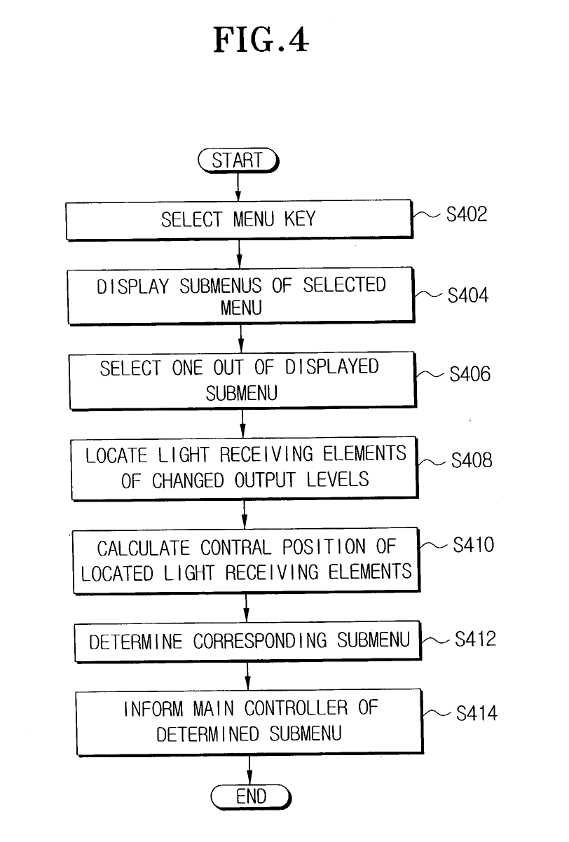

FIG. 4 is a flow chart illustrating an example of the operation of the input panel device according to an embodiment of the present invention. When one of the menu keys is selected out of the plurality of the menu keys 204 by the user in step S402, the display 202 displays submenus of an upper menu assigned to the selected menu key in step S404.

Using his or her finger, a user selects one of the submenus out of the displayed submenus in step S406. Although all of the luminous elements 206 normally emit light, if the user selects one of the submenus 207 displayed on the screen of the display 202 by using his or her finger, then the light from the luminous elements 206 corresponding to the selected submenu are partially obstructed by the user's finger. This causes the light receiving elements 208 which receive the emitted light from the luminous elements 208 to change their output levels.

The submenu calculator 214 determines the positions of the light receiving elements having the changed levels in step S408, and then calculates a central position of these positions in step S410. The submenu calculator 214 consequently compares the calculated value with the positions of the submenu stored in the storage 210 to thus locate the submenu corresponding to the calculated value in step S412.

After the submenu calculator 214 locates the submenu selected by the user, the controller 212 informs the main controller 300 of the selected submenu in step S414. The main controller 300 then controls the operator 400 to perform the function corresponding to the selected submenu.

Although the output levels of the light receiving elements are input to the submenu calculator 214 in the embodiment described above and shown in FIG. 2 to locate the positions of the light receiving elements having changed levels, another embodiment of the panel input device can include a light detector (not shown) for detecting the output levels of the light receiving elements.

According to the embodiments of the present invention described above, the menus can be selected promptly and easily by using the light receiving and luminance elements. While the invention has been shown and described with reference to certain embodiments, it will be understood by those skilled in the art that various changes in form and details may be made without departing from the spirit and scope of the invention as defined by the appended claims. Moreover, the foregoing embodiments and advantages are merely exemplary and are not to be construed as limiting the present invention. The embodiments of the present invention as described above can also be readily applied to other types of apparatuses. Many alternatives, modifications, and variations will be apparent to those skilled in the art.

What is claimed is:

1. An input panel device, adapted for use with an electronic device for inputting and selecting a desired operation of the electronic device, the input panel device comprising:
a plurality of menu keys;
a display which is adapted to display submenus pertaining to a selected menu upon selection of a menu key by the user;
a sensor array which is adapted to output signals of levels corresponding to a selected submenu upon selection of a submenu displayed on the display by the user; and
a controller, adapted to calculate a central position of the sensors having changed output levels among the sensor array, and to compare the calculated central position with positions of the submenus displayed on the display to determine the selected submenu and inform the electric device of the selected submenu.

2. The input panel device according to claim 1, further comprising a storage adapted to store information pertaining to positions and ranges of the submenus displayed on the display.

3. The input panel device according to claim 1, wherein the sensor array includes:
luminous elements disposed inside the display to emit light; and
light receiving elements disposed in positions corresponding to the luminous elements to receive the light from the luminous elements, such that the light from those of said luminous elements being in the vicinity of the selected submenu is obstructed from being received by their respective said light receiving elements upon selection of the submenu, resulting in said respective light receiving elements outputting signals having levels different from those that said respective light receiving elements output when receiving the light from said those luminous elements.

4. The input panel device according to claim 3, wherein the number of the light receiving elements is larger than the number of the luminous elements.

5. The input panel device according to claim 3, wherein:
the luminous elements emit at least one of infrared, visible or ultraviolet light.

6. A method for using an input panel device that is adapted for use with an electronic device for inputting and selecting a desired operation of the electronic device, the input panel device comprising a plurality of menu keys, a display, a sensor array and a controller, the method comprising:
selecting a menu key to cause the display to display submenus pertaining to the selected menu;
controlling the sensor array to output signals of levels corresponding to a selected submenu upon selection of a submenu displayed on the display by the user; and
controlling the controller to calculate a central position of the sensors having changed output levels among the sensor array, and to compare the calculated central position with positions of the submenus displayed on the display to determine the selected submenu and inform the electric device of the selected submenu.

7. The method according to claim 6, further comprising:
storing information pertaining to positions and ranges of the submenus displayed on the display.

8. The method according to claim 6, wherein the sensor array controlling step includes:
energizing luminous elements disposed inside the display to emit light; and
enabling light receiving elements disposed in positions corresponding to the luminous elements to receive the light from the luminous elements, such that the light from those of said luminous elements being in the vicinity of the selected submenu is obstructed from being received by their respective said light receiving elements upon selection of the submenu, resulting in said respective light receiving elements outputting signals having levels different from those that said respective light receiving elements output when receiving the light from said those luminous elements.

9. The method according to claim 8, wherein:
the number of the light receiving elements is larger than the number of the luminous elements.

10. The method according to claim 8, wherein:
the luminous elements emit at least one of infrared, visible or ultraviolet light.
